(19) United States
(12) Patent Application Publication
(10) Pub. No.: US 2005/0133458 A1
(43) Pub. Date: Jun. 23, 2005

(54) Perchlorate removal apparatus

(76) Inventor: Mirat D. Gurol, San Diego, CA (US)

Correspondence Address: FISH & RICHARDSON, PC, 12390 EL CAMINO REAL, SAN DIEGO, CA, 92130-2081, US

(21) Appl. No.: 11/020,913

(22) Filed: Dec. 23, 2004

Related U.S. Application Data
(60) Provisional application No. 60/532,762, filed on Dec. 23, 2003.

(51) Int. Cl. C02F 1/32

(52) U.S. Cl. 210/748; 210/206; 210/195.1

(57) ABSTRACT

An apparatus for reducing a concentration of ions of perchlorate in water. In one implementation, the apparatus includes an ultraviolet (UV) light source, and a reactor chamber to operate a fluidized bed of suspended iron particles. The reactor chamber facilitates UV light into the reactor chamber from the UV light source, in which the UV light is a catalyst for removing perchlorate ions. The apparatus includes a recirculation tank to use water and/or iron recirculated with the reactor chamber. Another implementation involves a thin-film reactor for the water and iron particles, in which the thin-film reactor is configured for the water to flow over a surface and mix with iron particles. The thin-film reactor implementation includes a separator apparatus to separate iron particles from the water, and an ultraviolet lamp to apply ultraviolet light to the water in the thin film reactor.

### CROSS REFERENCE TO RELATED APPLICATIONS

This application claims the benefit of priority from U.S. Provisional Application entitled “Perchlorate Removal Apparatus”, application No. 60/532,762, filed Dec. 23, 2003 by Mirat D. Gurol, the disclosure of which is incorporated by reference.

### TECHNICAL FIELD

The present disclosure relates to the treatment of potable water to reduce the level of perchlorate ions from potable water sources.

### BACKGROUND

Perchlorate has increasingly been found in sources of potable water. Several states have had confirmed perchlorate contamination in ground water and surface water. Mirat D. Gurol, et. al., (U.S. Pat. No. 6,531,065) described a method to remove perchlorate from water, particularly water intended for potable purposes, by chemically reducing the perchlorate ion to a more innocuous ion species by contacting water containing perchlorate ions with iron metal, and then removing the metal. The first type of perchlorate removal method refers to implementation I in U.S. Pat. No. 6,531,065. Gurol also described contacting perchlorate contaminated water with iron metal or a metal oxide in the presence of phosphoric acid to form a complex with perchlorate ion and adsorb the complex onto the iron, which is then removed from the water. The second type of perchlorate removal method refers to implementation II in U.S. Pat. No. 6,531,065.

### SUMMARY

Techniques and methods are disclosed that provide improvements for effective means for removing perchlorate from water. In particular, the current disclosure includes an apparatuses and systems that can be used for Implementation I described in the Gurol U.S. Pat. No. 6,531,065. Furthermore, one apparatus implements a technique to eliminate the need for a subsequent physical separation process for iron particles, such as sedimentation or filtration. Other apparatuses use subsequent physical separation process for iron particles from water that are efficient, safe, and inexpensive.

In one general aspect, the techniques feature an apparatus for reducing a concentration of ions of perchlorate in water that includes an ultraviolet (UV) light source to produce UV light, a reactor chamber configured to operate a fluidized bed of suspended iron particles, and a recirculation tank to use water recirculated with the reactor chamber. The reactor chamber is configured to receive the UV light, in which the UV light is a catalyst for removing perchlorate ions.

Advantageous implementations can include one or more of the following features. The reactor chamber can include a fluidized bed photochemical reactor (FBPR). The FBPR can include a cylindrical glass reactor and a ultraviolet (UV) lamp located in the middle of the FBPR. The FBPR can be in a vertical position with respect to a level ground surface, and the FBPR may be configured for water to flow in a direction upwards against the force of gravity. The FBPR can be in a fluidized bed mode to keep the iron particles in suspension, and the FBPR may be configured to allow penetration of UV light through the suspension.

The UV light source may be a low pressure mercury lamp or a medium pressure lamp.

The apparatus can be further configured to facilitate mixing of perchlorate ions with the iron particles in suspension. The reactor chamber can be configured to retain the iron particles in suspension within the fluidized bed when water is removed from the reactor chamber. The FBPR may include at least two concentric cylindrical tubes, in which two of the concentric cylindrical tubes may include an inner quartz tube with a UV lamp and an outer tube enclosing the reactor chamber, and the outer tube may be formed of Pyrex.

The apparatus may also include a radiometer to monitor an average light intensity. The radiometer may be configured to be calibrated with ferrioxaliate actinometry. The apparatus may be also configured to eliminate a subsequent physical separation process for iron particles, and may further involve a pump to adjust a flow rate through the reactor chamber. The pump can adjust a fluidized bed expansion and porosity.

The recirculation tank may be shielded from the atmosphere. Nitrogen gas can be sent into the recirculation take to help create a redox condition. The recirculation tank can be further configured to monitor any of the following: oxygen concentration, oxidation/reduction potential, and temperature. Also, the recirculation tank can be configured for at least any one of a gas exhaust, a liquid sampling, and a chemical addition.

The apparatus may include at least one heat exchanger to set the temperature of the solution in the recirculation tank, in which the heat exchanger is configured to set the temperature to below 100° C. The apparatus may also include a centrifugal separator connected between an output of the reactor chamber and an input of the recirculation tank.

In another general aspect, techniques feature a system to reduce a concentration of perchlorate ions in a water solution. The system includes a reactor chamber having the water solution and suspended iron particles, a recirculation tank connected with the reactor chamber and configured to receive water, a separator apparatus to keep iron separated from water reaching the recirculation tank, and an ultraviolet (UV) lamp to apply ultraviolet light to the water solution in the reactor chamber. The water solution includes perchlorate ions, and the reactor chamber is configured for the water solution to flow through the reactor chamber and to contact the suspended iron particles.

Advantageous implementations can include one or more of the following features.

The recirculation tank and the reactor chamber can be configured to recycle water to reduce a concentration of perchlorate ions from the water. The system may include a pump to recycle water between the recirculation tank and the reactor chamber. The reactor chamber can be further configured to keep iron particles suspended in the reactor chamber when water is removed from reactor chamber.

The separator apparatus may include a filter to filter the iron particles from the water and/or the system may further involve a centrifugal separator to filter the iron particles from the water. The system can be configured such that substantial portion of the iron particles in the system are kept suspended in the reactor chamber. A first output of the centrifugal separator may be connected with the recirculation tank and may be an output for water. A second output of the centrifugal separator can be configured for iron particles. The system may have one or more connections between the centrifugal separator and the reactor chamber to recirculate iron particles filtered in the centrifugal separator. The one or more connections can involve an injector apparatus to retrieve the iron particles from the second output of the centrifugal separator and send the iron particles to the reactor chamber.

In another general aspect, techniques feature a system to reduce an amount of perchlorate ions in a water solution, in which the system includes a fluidized bed photochemical reactor (FBPR) holding the water solution and the suspended iron particles, an ultraviolet (UV) source to apply UV light to the water solution in the FBPR, a recirculation tank connected with the FBPR to hold water with a reduced concentration of perchlorate ions, and a pump configured to recirculate water through the recirculation tank and the reactor chamber. The water solution includes perchlorate ions. The FBPR is configured to place the water solution in contact with the suspended iron particles, and the suspended iron particles are left in the FBPR when the water is removed. UV light serves as a catalyst in a reaction for removing the perchlorate ions from the water solution.

Advantageous implementations can include one or more of the following features.

The FBPR can be configured to keep the iron particles in suspension in a fluidized bed. The FBPR may include at least two concentric cylindrical tubes, in which two of the concentric cylindrical tubes comprise an inner quartz tube with the UV light source and an outer tube enclosing the FBPR.

In another general aspect, techniques feature a system to reduce a concentration of perchlorate ions in water. The system involves a thin film reactor for the water and iron particles, a separator apparatus to separate iron from the water, and an ultraviolet (UV) lamp to apply ultraviolet light to the water in the thin film reactor. The water includes perchlorate ions, in which the thin film reactor is configured for the water to flow over a surface and contact iron particles.

Advantageous implementations can include one or more of the following features.

The system may also include an oxidation/reduction potential (ORP) monitor. The UV lamp may not contact the water, and thereby can reduce the potential for fouling the quartz surface. The thin-film reactor can have a controlled atmosphere where the perchlorate reaction takes place, and can allow adequate mechanical mixing and UV exposure. The iron and water slurry can be recirculated until desired concentration is met. Surface weiring can control the flow for consistent film thickness to accommodate large sheet reactors. The angle of the thin-film reactor can be set to optimize flow condition keeping iron in suspension. The surface of the thin-film reactor may be in different configurations, such as a spherical, circular, spiral, star, square, rectangle, and the like.

The details of one or more implementations of the present disclosure are set forth in the accompanying drawings and the description below. Other features, objects, and advantages of the present disclosure will be apparent from the description and drawings, and from the claims.

### DESCRIPTION OF DRAWINGS

FIG. 1 shows an exemplary change of perchlorate concentration using iron metal.

FIG. 2 shows an exemplary change of perchlorate concentration using iron metal and UV light.

FIG. 3 illustrates effects of UV light intensity on changing perchlorate concentration.

FIG. 4 illustrates an effect of initial solution pH on the change of perchlorate concentration in Fe⁰-UV systems.

FIG. 5 is an exemplary diagram of the Fluidized Bed Photochemical Reactor (FBPR) system.

FIG. 6 shows an exemplary reactor chamber.

FIG. 7 is an exemplary flow diagram of an apparatus with a centrifugal separator.

FIG. 8 illustrates an exemplary flow diagram for an iron down-flow reactor.

FIG. 9 illustrates a table with experimental conditions of the iron down-flow reactor system of FIG. 8.

FIGS. 10-11 show a thin-film reactor system.

FIG. 12 shows exemplary results of the thin-film reactor system.

Like reference symbols in the various drawings indicate like elements.

### DETAILED DESCRIPTION

The present disclosure relates to methods and techniques for implementing and using apparatuses for perchlorate destruction. The present disclosure contemplates apparatus and systems for implementation I (from U.S. Pat. No. 6,531,065), for the efficient, safe and inexpensive removal of perchlorate from water.

In one implementation, the present disclosure contemplates the ability of iron metal to reduce perchlorate ion concentration in water whereby perchlorate ion is chemically reduced. In this regard, iron metal can effectively reduce perchlorate ions to a more environmentally innocuous chemical species. Iron metal, as is used in the context of the present disclosure, may include zero valent iron or Fe⁰. However, the present disclosure does not exclude iron metal in mixtures with other metals or mineral oxides.

An effective amount of iron metal can refer to an amount needed to reduce a given concentration of perchlorate to below a desired concentration, such as, about 20 ppb for example. Increased perchlorate removal may correlate with increased iron metal concentrations and concentrations of iron metal can be determined by initial concentrations of perchlorate. However, iron metal may be present in a concentration of about 1 g/L to about 100 g/L or higher. In one implementation, for example, the metal concentration may be about 10 g/L and higher, and maybe even 100 g/L and higher.

The iron metal may be in powdered form, such as an 80 to 100 mesh powder. However, the iron metal may be in other forms such as granules or filings. The iron metal in a given form may be circulated freely in a system or be present as a packed bed.

With respect to exemplary reaction conditions for implementation I, the pH may be kept in the range of about pH 4 to about pH 8 since a highly basic medium may favor the formation of precipitates, such as iron hydroxide, which may eventually inhibit further dissolution. In some exemplary implementations, the pH may be kept in a range of about 6.6 to about 7.5, and the temperature may be at room temperature. In one exemplary implementation, the reaction may be kept under substantially anoxic conditions which means that the reaction conditions can be substantially free of oxygen. In another exemplary implementation, the reaction may be kept under substantially anoxic conditions, and preferably in the presence of controlled amounts of oxygen.

Implementations of the present disclosure may involve iron metal directly, and may imply that the reduction occurs by electron transfer, from the Fe⁰ surface to the adsorbed chlorine-inorganic compounds. In this regard, two hypothetical reactions of iron metal with perchlorate ion may be stated as follows:

Case I
Fe⁰⇄Fe²⁺+2e⁻ ΔG+=−20.31 kcal/mol
ClO₄⁻+8H⁺+8e⁻⇄Cl⁻+4H₂O ΔG°=−256.47 kcal/mol

Balanced Equation:
4Fe⁰+ClO₄⁻8H⁺⇄4Fe^{2e}+Cl⁻+4H₂O ΔG°=−337.71 kcal/mol

Case II
Fe⁰⇄Fe²⁺+2e⁻ ΔG°=−20.31 kcal/mol
ClO₄⁻+2H⁺+2e⁻⇄ClO₃⁻+H₂O ΔG°=−54.88 kcal/mol

Balanced Equation:
Fe⁰+ClO₄⁻+2H⁺⇄ClO₃⁻+Fe²⁺+H₂O ΔG°=−75.19 kcal/mol

Both reactions are thermodynamically favorable, as indicated by a negative ΔG° value. This means that they can take place, more or less, spontaneously. However, perchlorate ion originates as a contaminant in ground and surface waters from the dissolution of its ammonium, potassium, magnesium, or sodium salts. The resultant anion (ClO₄⁻) can persist for many decades under typical groundwater and surface water conditions. In this regard, perchlorate is a kinetically stable ion, which means that reduction of the chlorine atom from a +7 oxidation state in perchlorate to −1 or +5 oxidation state, as chloride or chlorate ion, may not occur readily.

Although perchlorate reduction with iron metal, according to this implementation of the present disclosure, reduces perchlorate concentration, further promotion can overcome kinetic barriers and facilitate efficient perchlorate removal. Therefore, according to an aspect of the disclosure, a catalyst can increase the speed of the destruction of perchlorate ion, thereby, potentiating the effect of a reducing agent to remove perchlorate from water. In particular, the addition of an appropriate catalyst with iron metal can promote reduction of perchlorate ion concentration by facilitating the reduction of perchlorate.

A “catalyst” can refer to a substance or material which accelerates a chemical reduction of perchlorate with iron metal. A catalyst can also refer to the input of energy, such as light or heat. For example, one type of catalyst is ultraviolet light (UV light), which is light of the spectrum just beyond violet light on the short-wavelength side. In particular, UV light here can refer to light with wavelengths in the range of about 110 to about 4000 Å that can be emitted, for example, by sunlight or the carbon, mercury-vapor and tungsten lamps.

Reduction of perchlorate can be accelerated by using iron metal and irradiation with UV light. The UV light may act as a catalyst to make the reaction faster, or may act as an energy input which excites the perchlorate ion. In this regard, the role of UV light may be to activate perchlorate ion from its ground state to an excited state, and thus accelerates its reduction. Accordingly, implementation I also includes methods for reducing perchlorate ion concentration in water that involve contacting water containing the perchlorate ion with an effective amount of iron metal in the presence of a catalyst, such as UV light. The intensity of the UV light may directly influence reduction of perchlorate ion with iron metal, with higher intensities generally correlating with higher reduction rates.

An iron oxide may refer to a material that includes combinations of either iron and oxygen or iron, oxygen, and hydrogen. For example, materials may include substantially iron and oxygen, substantially iron and hydroxide groups, and/or materials containing iron with combinations of oxygen and hydroxide groups, i.e., iron oxide hydroxides.

The step(s) of removing the iron metal or iron oxide can be accomplished by methods of solids removal. For example, removal can be effected by simple filtration of particles with an appropriate mesh filter. Other methods include gravity settling, granular media filtration and centrifugation. Separation of particles may be eliminated entirely in implementation I, for example, by UV exposure and passing water containing perchlorate over a packed column.

The present disclosure, thus generally described, can be understood more readily by reference to the following examples, which are provided by way of illustration and are not intended to be limiting of the present disclosure.

Materials and Methods

The iron metal, Fe⁰, can be used in some exemplary experiments and may be electrolytically-produced 100 mesh powder (certified grade, 95%; Fisher) with a surface area of 0.74 m²/g. The iron oxide, FeOOH, can be a hydrated, 30-50 mesh powder (catalyst grade; Aldrich Chemical Co.) with surface area of 120 m²/g. In one exemplary implementation to study of the effect of UV radiation on perchlorate reduction, a quartz reactor of 0.8 L may be used with a RAYONET Photochemical Reactor, which contains 16 low pressure mercury lamps that produces a light intensity, 1% of which is at 185 nm, and 99% at 254 nm. The chamber can accommodate sixteen low pressure mercury lamps, with a total emitted light intensity of 26 watts, and an incident light intensity of 3.4 watts, as measured by actinometry. For the continuous circulation of solution and iron metal, a MASTERFLEX hydraulic pump with the speed of 60-600 rpm (Cole-Palmer) can be used. After sampling, to remove the residual particles of iron metal or iron oxide from the samples, a 0.45 μm filter (Micron separations Inc.) may be used.

Experiments with Fe⁰-UV System

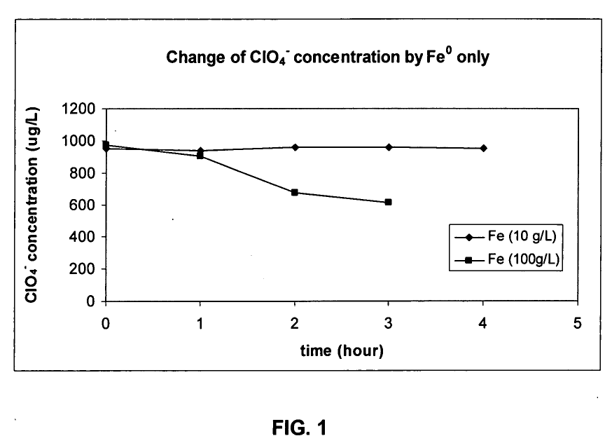

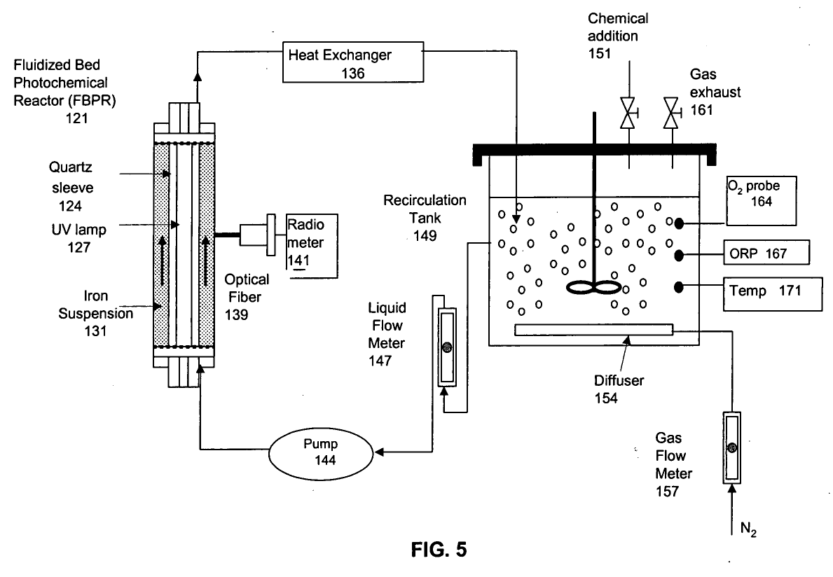

Some experiments below (e.g., FIGS. 1-4) may be similar to some experiments in the Gurol U.S. Pat. No. 6,531,065. Other experiments (e.g., FIGS. 5-12) may show that the underlying methods and processes in Implementation I of the U.S. Pat. No. 6,531,065 are safe, effective, and inexpensive when implemented in the apparatuses and systems described below.

Some exemplary implementations of these experiments can be designed to investigate the chemical reduction of perchlorate in Fe⁰-UV system under anoxic conditions. Deionized water can be used after being degassed with a vacuum pump at pressure gauges of 40-50 cm and purged with N₂ gas to make anoxic conditions. Solutions of perchlorate may be prepared at 0.8 L quartz reactor with varying iron concentrations and pH values. The iron concentration range, in some implementations, may be between 10 g/L-100 g/L. The initial pH range may be kept between 5.0 and 8.0, a range most common for natural waters. Dilute HCl and NaOH solutions can be used to adjust the pH of the test solutions.

The Fe⁰—ClO₄⁻ solution can be continuously mixed by a MASTERFLEX hydraulic pump to provide sufficient contact between iron metal and perchlorate. In an exemplary experiment, samples may be taken from the reactor at specific times from a sampling port. The samples may be filtered to remove iron particles. A portion of samples can be used for ion chromatography analysis, and the remainder can be used to measure pH.

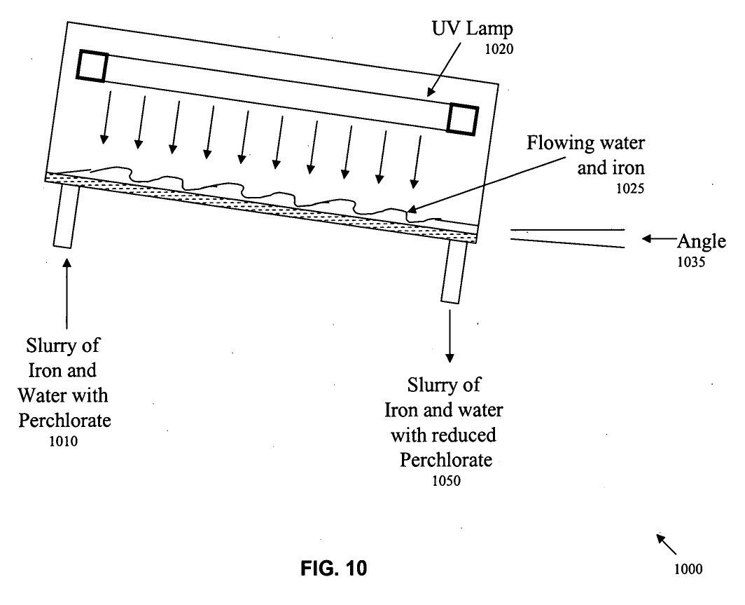

Some other exemplary experiments, as described below with respect to FIGS. 5-12, used other exemplary apparatuses and systems. For instance, FIGS. 5-8 involve plexyglass chambers, which are covered with a UV protective film on the surface, and quartz sleeves to house the UV lamps. FIGS. 10-12 involve a third reactor system that involves a thin film of water that flows over a surface parallel to the surface, and UV lamp is placed over the thin film without touching the water surface.

Two different types of lamps can be employed in the exemplary apparatuses of FIGS. 5-12: a low pressure mercury lamp with light intensity output of 13.8 watt; and a medium pressure lamp with light intensity of 2400 w total. Low pressure mercury lamps can emit at about 254 nm and about 185 nm wavelengths. Medium pressure lamps can emit at wavelengths that can vary with the temperature of the lamps. The following two different types of zero-valent iron can be used in the exemplary experiments: (1) Fisher iron powder 160-3, finer than 100 mesh, electrolytic 99%+total iron; and (2) ARS Technologies, Inc., food quality iron, H-200, with a surface area 0.1 m2/g, and a particle size varying between 100 mesh and 325 mesh.

The experiments in reference to FIGS. 5-12 are designed to investigate the chemical reduction of perchlorate in Fe⁰-UV system under controlled partially anoxic conditions. Deionized water, tap water or water containing bicarbonate ions may be used in the experiments. Solutions of perchlorate can be prepared with varying iron concentrations and pH values. The iron concentration range can be between 10 g/L-300 g/L. The initial pH range may be kept between 5.0 and 8.0, a range most common for natural waters. Dilute HCl and NaOH solutions can be used to adjust the pH of the test solutions. Samples can be taken from the reactor at specific times during the experiments from a sampling port. Metallic iron particles can be removed by various techniques, including filtration, centrifugation or by magnets. Dissolved iron can be removed by aeration or ozonation, and followed by filtration. A portion of samples may be used for ion chromatography analysis, and the remainder may be used to measure pH and iron. Oxidation/reduction potential (ORP) may also be monitored and controlled.

Analytical Methods

In an exemplary implementation, an analytical method can involve AS11 analytical and AG11 guard columns, and a conductivity detector and an anion trap column (ATC) to remove anionic contaminants from the eluent. Since conventional analytical methods have difficulties in separating chloride (Cl⁻), chlorite (ClO₂⁻), and chlorate (ClO₃⁻) ions from each other, a modified analytical method may be used by changing the eluent mode from isocratic to gradient mode in order to check the feasibility of chemical reduction of perchlorate.

The modified method may use a gradient mode, in which 10 mM NaOH can be used for 0 through 7 minutes to separate Cl⁻, ClO₂⁻, ClO₃⁻, and 100 mM NaOH was used for 7 through 20 minutes to detect perchlorate with reasonable retention time. In order to quantify perchlorate at low μg/L levels, chromatographic conditions can be optimized in terms of retention time, peak shape, and baseline noise. The use of AS 11 column with an eluent of 100 mM sodium hydroxide may permit the elution of perchlorate within a reasonable time frame. In order to minimize baseline noise for this application, the suppressor may operate at 300 mA in the external water mode. A 100 μL sample loop can be used to minimize the effect of void volume inside the reactor for the experiment. A flow rate of 1 mL/min can be used.

In one implementation, the working eluents may be prepared in degased deionized water. For example, a 50% w/w sodium hydroxide solution (Fisher Scientific) can be used to prepare eluent. Sodium chloride (NaCl; Fisher Scientific), sodium hypochlorite (NaOCl; available chlorine 10˜3%; Aldrich Chemical Co.), sodium chlorite (NaClO₂, 80%; Aldrich Chemical Co.), sodium chlorate (NaClO₃, 99%; Aldrich Chemical Co.), and sodium perchlorate (NaClO₄, 99%; Aldrich Chemical Co.) can be used for the calibration of oxychlorine species.

Calibrations may be carried out with working standards of oxychlorine anions prepared in deionized water. Working standards can be injected into an ion chromatography machine to produce calibrations.

Perchlorate Removal by Fe⁰ and Fe⁰-UV Systems

### EXAMPLE 1

Perchlorate concentration reduction may be carried out using iron metal. FIG. 1 shows exemplary results of perchlorate reduction obtained by Fe⁰. The reduction of perchlorate concentration of the solution with time can be closely related to the initial iron metal concentration. The amount of iron metal used may be a limiting factor for perchlorate reduction as follows:
Fe⁰+ClO₄⁻+2H⁺→ClO₃⁻+Fe²⁺+H₂O
4Fe⁰+ClO₄⁻+8H₊→Cl⁻+4Fe²⁺+4H₂O

The direct role of Fe⁰ as a reactant in the equations above may imply the involvement of reactive sites on the metal surface and, therefore, that the condition and quantity of the metal surface in a reaction system may influence the rate of perchlorate reduction. In the presence of 100 g/L of iron (100 mesh) in one exemplary implementation, 37% of perchlorate reduction occurred within 3 hours and ΔpH (ΔpH=pH_{f}−pH₀) is 1.59 with pH₀ of 6.35, without pH control.

### EXAMPLE 2

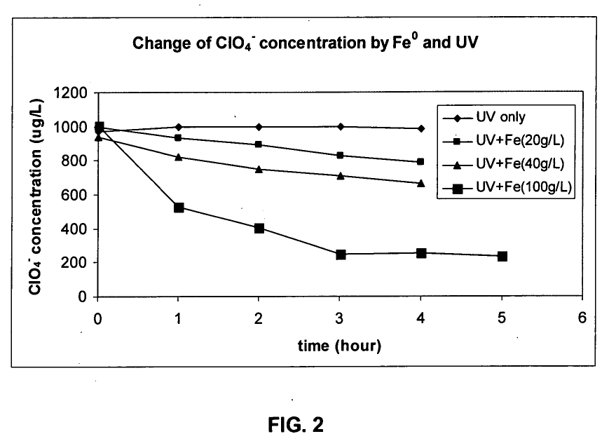

In another exemplary implementation, reduction of perchlorate concentration is conducted with a Fe⁰-UV system. Different experiments may be in this manner with varying concentrations of iron metal. FIG. 2 shows the effects of the Fe⁰-UV system on perchlorate reduction with varying the concentration of iron metal. In the presence of 100 g/L of iron (100 mesh) and UV, 76.7% of perchlorate reduction occurs within 5 hours with irradiation and ΔpH is 1.92 with pH₀ of 6.61, without pH control. It is apparent from this example that UV light can act as a catalyst which can make the reaction faster. Alternatively, UV light can act an energy input which may make perchlorate excite.

### EXAMPLE 3

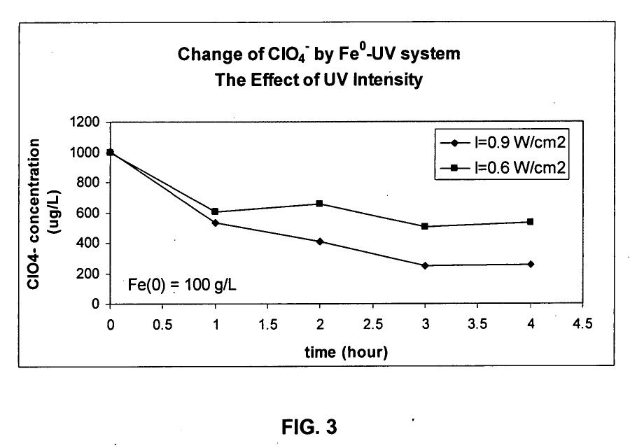

Another exemplary experiment can be carried out by varying the intensity of UV light in the Fe⁰-UV system. The effect of light intensity on perchlorate reduction in the Fe⁰-UV system over the experimental period is shown in FIG. 3. The light intensity can be measured by ISV Radiometer (manufactured by UVP, Inc.), which can read the intensity of the incident light into a specified dosimeter surface. The results of FIG. 3 show that overall UV light intensity influences the reduction of perchlorate.

### EXAMPLE 4

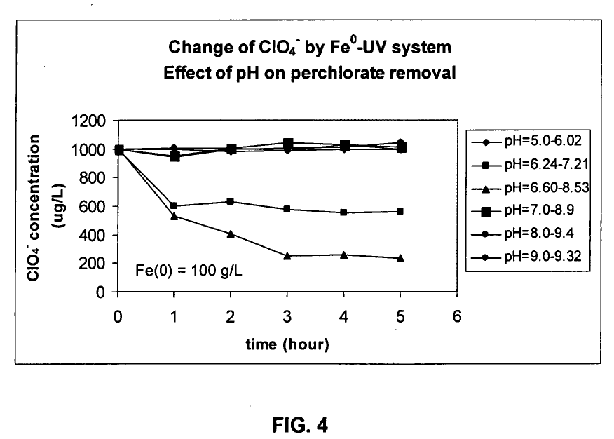

In this exemplary experiment, initial pH in the Fe⁰-UV system is varied to examine acidic and basic effects on perchlorate concentration. The effect of initial pH on perchlorate removal in the Fe⁰-UV system is shown in FIG. 4. Within the pH range of 6.6 to 7.5, efficient perchlorate reduction is possible. The basic pH may favor the formation of iron hydroxide (precipitates), which may eventually form a surface layer on the metal that inhibits its further dissolution.

Perchlorate Ion Concentration Reduction Apparatus

In general, the apparatuses and experimental results shown in reference to FIGS. 5-12 may have some experimental conditions that vary from those shown in reference to FIGS. 1-4 and U.S. Pat. No. 6,531,065. However, FIGS. 5-12 can show systems, apparatuses, and experiments to show that the underlying process described with respect to U.S. Pat. No. 6,531,065 is effective in removing and reducing perchlorate concentrations in water in a safe, inexpensive, and efficient manner. The apparatuses and systems are not limited to implementing the exact methods of implementations I as described above or the exact experimental results and conditions as described below (e.g., the exact conditions of temperatures, concentrations, etc.), but may vary somewhat and still perform similar operations and generate similar results or better.

The apparatus shown in FIG. 5 can employ the method(s) of implementation I (e.g., UV radiation and metallic iron). A primary part of the apparatus is the Fluidized Bed Photochemical Reactor (FBPR) 121. In the illustrated implementation in FIG. 5, the FBPR includes a cylindrical glass reactor with a UV lamp 127 placed in the middle. The reactor 121 can be stabilized in vertical position and may contain appropriate amounts of iron particles as filler. The reactor 121 can be operated in fluidized bed mode to keep the iron particles in suspension 131, and also to allow good penetration of UV light through the suspension 131. The apparatus can bring the perchlorate molecules and iron particles to close proximity of the lamp surface while providing good mixing. A flow rate through the reactor 121 can be adjusted by a pump 144 to provide the desired bed porosity or bed expansion.

Because of their high density (e.g., 7.874 g/cm³) and as a result high settling velocity, even very small size iron particles can remain within the fluidized bed. The apparatus can eliminate the need for a subsequent physical separation process for iron particles, such as sedimentation or filtration. The FBPR 121 can have two concentric cylindrical tubes, an inner quartz tube 124 accommodating the cylindrical UV lamp 127, and an outer Pyrex tube enclosing the annular reaction chamber.

The FBPR 121 can be operated in a recirculation mode, in which the fluid flow is recirculated in the apparatus. The perchlorate contaminated water can be pumped vertically (e.g., upwards, against the force of gravity) through the FBPR 121 into a recirculation tank 149 and back into the FBPR 121. The recirculation tank 149 may be shielded from the atmosphere. Nitrogen gas can be applied and sent through a diffuser 154 to create the appropriate redox conditions in the recirculation tank 149. Probes 164, 167, 171 placed in the recirculation tank 149 can monitor oxygen concentration, oxidation/reduction potential (ORP), and temperature conditions, respectively. In addition, the recirculation tank 149 may be equipped with ports 161, 147,151 for respective gas exhaust, liquid sampling, and chemical additions. The temperature of the perchlorate solution can be maintained below 100° C. by using one or more heat exchangers 136. A radiometer 141 can continually monitor the average incident light intensity, and the radiometer 141 may be calibrated with ferrioxalate actinometry.

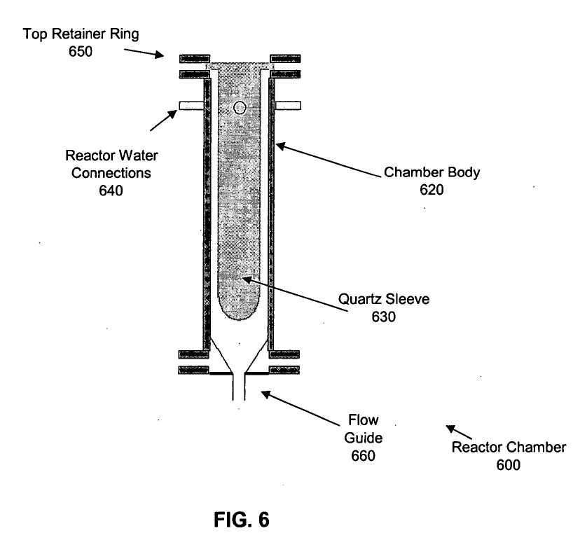

FIG. 6 shows an exemplary reactor chamber 600. The reactor chamber 600 includes a plexiglass or polycarbonate chamber body 620. The chamber body 620 is covered with a UV protective film on the surface, and quartz sleeves 630 to house one or more UV lamps. Various types of UV lamps may be used. In one implementation, the UV lamp may be a low pressure mercury lamp with a light intensity output of around 13.8 watt. The low pressure mercury lamp may emit light at around 254 nm or 185 nm wavelengths. In another implementation, a medium pressure lamp can be used with a light intensity of around 2400 w. The medium pressure lamp may emit light at wavelengths that vary with the temperature of the lamp.

The reactor chamber has a top retainer ring 650 and reactor water connectors 640. In one implementation, there are 4 reactor water connections per chamber. The reactor water connectors 640 may be may made of polycarbonate material. The reactor chamber 600 includes a water flow guide 660. The water flow guide 660 may be made out of stainless steel.

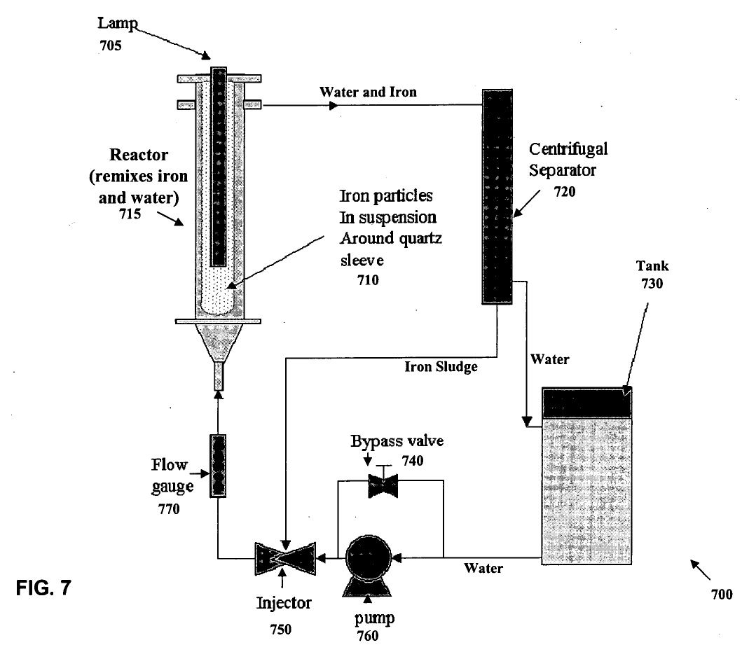

FIG. 7 shows an exemplary diagram for a fluidized bed reactor system 700. The system 700 is configured to recirculate water and iron to remove perchlorate from the water. The chamber 715 is used to mix (or remix) water and iron so that the iron can reduce perchlorate from the water, and the centrifugal separator 720 is used to separate water and iron after perchlorate has been removed from the water.

In FIG. 7, water flows upwards in the reactor chamber (e.g., a flow upwards and against gravity) to substantially keep the iron particles suspended in the reactor chamber 715. The flow into the centrifugal separator 720 includes a substantially larger percentage of water than iron. Water and a small amount of iron flows from the reactor chamber 715 to a centrifugal separator 720 and either to a tank 730 or an injector 750. The centrifugal separator 720 separates iron from the water. A substantial amount of iron is sent back into the reactor 715 using an injector 750. The iron sent out of the centrifugal separator 720 into the injector is substantially a dense iron sludge. A substantial amount of the water filtered in the centrifugal separator 720 is sent from the centrifugal separator 720 into the tank 730. The water sent into the tank 730 has lower perchlorate concentration after traveling through the reactor 715.

The injector 750 can allow circulation in the system so that a single pump is used in the system (e.g., pump 760). In another implementation, two pumps may be used in the system if the injector 750 is not used in the system. For example, one pump may be used to create the pressure to send the water from the tank 730 and the iron sludge from the centrifugal separator 720 into the reactor 715, and a second pump may be used to create the pressure to force the water and iron out of the reactor 715 and into the centrifugal separator 720.

Water sent from the tank 730 flows into a pump 760 or through a bypass value 740 to bypass the pump 760. The injector 750 sends water from the pump 760 to the water flow gauge 770, and into the reactor to remix the water and iron solution 715. The reactions may be monitored by measuring the pH, the ORP (oxidation/reduction potential), the perchlorate dissolved, and/or the total iron concentrations over time. In one implementation, the progress of these reactions are monitored in the tank 730.

The iron in the system 700 is kept in the reactor 715 and/or the centrifugal separator 720. The reactor chamber 715 may include one or more low pressure mercury lamps 705. In one exemplary experiment of system 700, 125 ppb of perchlorate can be removed in 6 minutes of reaction time with an initial perchlorate concentration of 1076 ppb using 100 gram/L of food grade iron and low pressure mercury lamps.

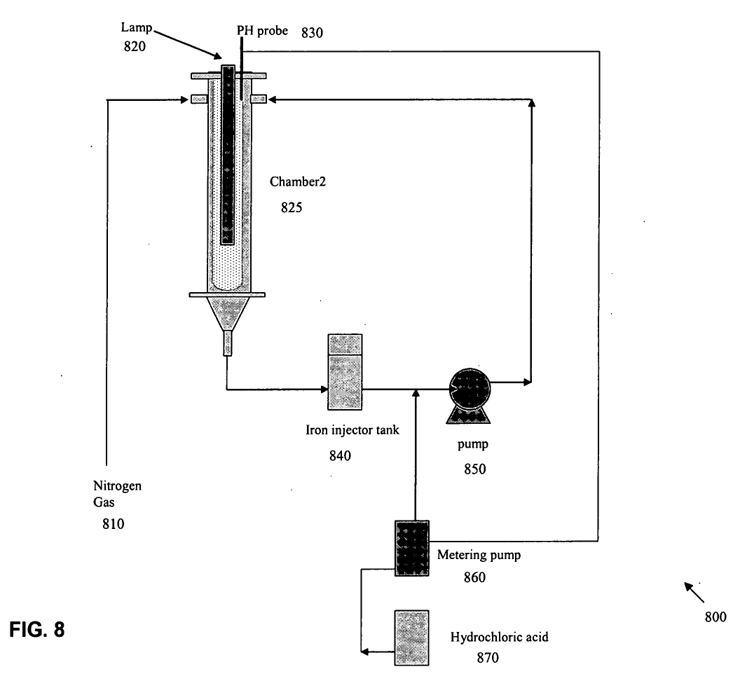

FIG. 8 illustrates an exemplary flow diagram for an iron down-flow reactor system 800. The iron down-flow reactor system 800 is designed to have the water and the iron particles flow downward (e.g., in the direction of gravity) from the reactor chamber 825. Iron and water can flow to the iron injector tank 840, and the pump 850 can create the pressure to send the water and iron back into the reactor chamber 825. The reactor chamber 825 also includes inlets for nitrogen gas 810 and a pH probe 830. Both water and iron are recycled back to the reactor. The reactor chamber 825 can have either the low pressure lamp or the medium pressure lamp 820, in which the temperature of the lamp 820 can be adjusted by circulating air. The system 800 also has a metering pump 860 to pump hydrochloric acid 870 to keep the pH of the solution in the reactor chamber 825 at preset levels.

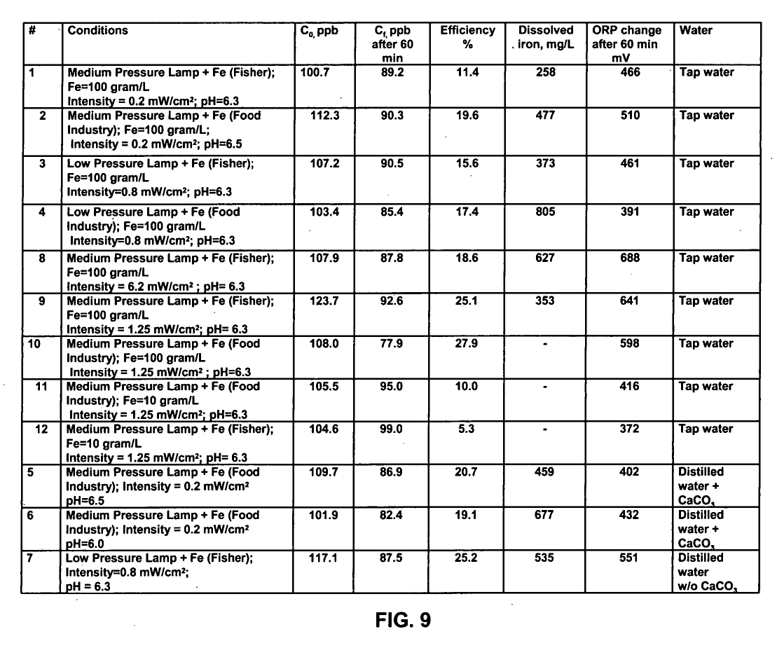

FIG. 9 illustrates a table with the experimental conditions of the iron down-flow reactor system 800 of FIG. 8. The table illustrates the effects of iron dosage, iron type, UV light intensity, and water quality. For example, the rate of perchlorate removal can depend upon the light intensity and the type of the iron used.

Some exemplary results of the system 800 can indicate that the perchlorate removal is directly proportional to the concentration of metallic iron and hydrogen ion, light intensity, and indirectly proportional to the dissolved iron concentration. There may also be an optimum ORP value for the reaction that is proportional to the partial pressure of oxygen in air above the water being treated. In one exemplary implementation, an empirical rate expression for the reaction can be provided by the following formula:

$$\text{Rate of perchlorate reaction} = \frac{{{{kI}_{i n}^{a} [ {Fe}^{0} ]}^{b} [ {H}^{+} ]}^{c} {P}_{o2}^{d}}{[ {Fe}^{+ 2} ] ( K + {P}_{o2}^{e} )}$$

FIG. 10 shows a thin-film reactor 1000. The reactor 1000 is designed to eliminate the direct contact of UV quartz tube with water. The reactor 1000 involves a thin film of water (and iron) that flows (1025) over a surface parallel to the surface, and UV lamp 1020 is placed over the thin film without touching the water surface. The reactor 1000 has an inlet that receives a slurry of iron and water with perchlorate 1010. The reactor 1000 is adjusted at an angle 1035 to permit the water to flow over the surface and be exposed to the UV light 1020. The reactor has an outlet for the slurry of iron and water with reduced amounts of perchlorate. The ORP of the reactor 1000 can be adjusted by injecting low levels of oxygen into the system and by removing dissolved iron from the water when the iron reaches high concentrations by precipitation.

Some features of the reactor include the following implementation advantages. The UV lamp 1020 does not contact the water, and thereby reduces the potential for fouling the quartz surface. The reactor 1000 can have a controlled atmosphere where perchlorate reaction takes place, and can allow adequate mechanical mixing and UV exposure. The iron and water slurry can be recirculated until desired concentration is met. Surface weiring can control the flow 1025 for consistent film thickness to accommodate large sheet reactors. The angle 1035 can be set to optimize flow condition keeping iron in suspension. The surface may be in different configurations, such as a sphere, a circle, a spiral, a star, a square, a rectangle, and the like.

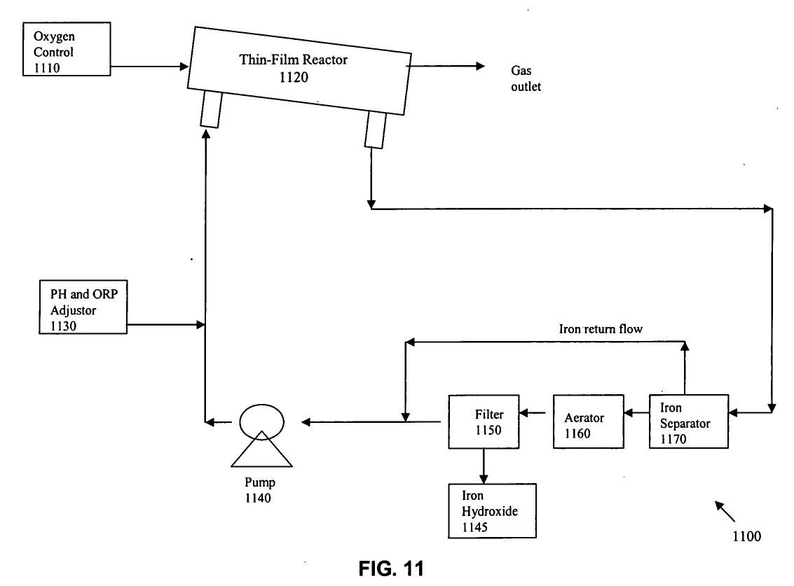

FIG. 11 shows a system for a flow diagram 1100 of the thin-film reactor. The thin-film reactor 1120 can be placed at an angle to allow an iron and water slurry to flow over the surface and be exposed to UV light. The water going into the reactor 1120 contains higher amounts of perchlorate than the water coming out of the reactor 1120.

The thin-film reactor 1120 can include an inlet for oxygen control 1110 and a gas outlet. The reactor 1120 has an inlet for the iron an water slurry. A pump 1140 can send the slurry into the reactor 1120, which can be adjusted by a pH and ORP adjustor 1130.

The sludge coming out of the reactor 1120 enters an iron separator 1170 that separates iron to send to the pump 1140 and water to send to an aerator 1160. After water is aerated with the aerator 1160, the water is filtered 1150 into iron hydroxide 1145 and water. The water from the filter 1150 is sent into the pump 1140 to recycle to the thin-film reactor 1120 for further perchlorate removal.

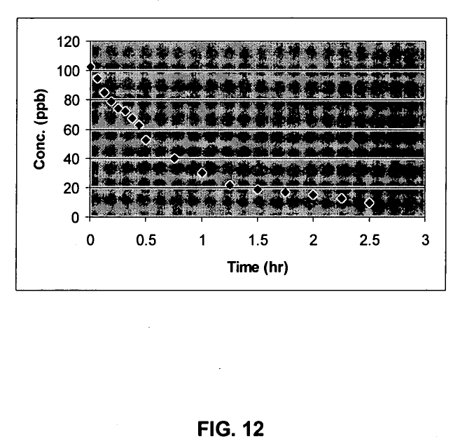

FIG. 12 shows some exemplary results of the thin-film reactor system 1100. The results show that initial perchlorate concentrations of about 100 ppb can be reduced to less than 10 ppb in 2.5 hours of UV exposure time by using 100 gram/L of metallic iron.

A number of implementations of the present disclosure have been described. Nevertheless, it will be understood that various modifications may be made without departing from the spirit and scope of the present disclosure. For example, the apparatus in FIG. 5 may have a separate storage tank for collecting purified water. Alternatively, the recirculation tank 149 and/or the FBPR 121 in FIG. 5 may have numerous ports for monitoring one or more conditions. The reactor may also involve the flow of perchlorate-containing water as a thin film on a layer of iron horizontally or vertically as in gravity filtration. In addition, iron can be pumped through this type of reactor as part of the flowing water. The UV lamps can be placed over the surface of water without touching the water. The apparatuses may use UV light and other compounds, such as carbon/iron compounds, to enhance the reaction by causing electrons to be released from particle surfaces. Accordingly, other implementations are within the scope of the following claims.

1. An apparatus for reducing a concentration of ions of perchlorate in water comprising:
an ultraviolet (UV) light source to produce UV light.
a reactor chamber configured to operate a fluidized bed of suspended iron particles, the reactor chamber is configured to receive the UV light, wherein the UV light is a catalyst for removing perchlorate ions; and
a recirculation tank to use water recirculated with the reactor chamber.

2. The apparatus of claim 1, wherein the reactor chamber comprises a fluidized bed photochemical reactor (FBPR).

3. The apparatus of claim 2, wherein the FBPR comprises a cylindrical glass reactor and a ultraviolet (UV) lamp located in the middle of the FBPR.

4. The apparatus of claim 2, wherein the FBPR is in a vertical position with respect to a level ground surface.

5. The apparatus of claim 4, wherein the FBPR is configured for water to flow in a direction upwards against the force of gravity.

6. The apparatus of claim 2, wherein the FBPR is in a fluidized bed mode to keep the iron particles in suspension, and wherein the FBPR is configured to allow penetration of UV light through the suspension.

7. The apparatus of claim 6, wherein the UV light source comprises a low pressure mercury lamp.

8. The apparatus of claim 6, wherein the UV light source comprises a medium pressure lamp.

9. The apparatus of claim 2, wherein the apparatus is further configured to facilitate mixing of perchlorate ions with the iron particles in suspension.

10. The apparatus of claim 9, wherein the reactor chamber is configured to retain the iron particles in suspension within the fluidized bed when water is removed from the reactor chamber.

11. The apparatus of claim 2, wherein the FBPR comprises at least two concentric cylindrical tubes, wherein two of the concentric cylindrical tubes comprise an inner quartz tube with a UV lamp and an outer tube enclosing the reactor chamber, wherein the outer tube comprises Pyrex.

12. The apparatus of claim 2, wherein the apparatus further comprises a radiometer to monitor an average light intensity.

13. The apparatus of claim 2, wherein the radiometer is configured to be calibrated with ferrioxaliate actinometry.

14. The apparatus of claim 1, wherein the apparatus is further configured to eliminate a subsequent physical separation process for iron particles.

15. The apparatus of claim 1, wherein the apparatus further comprises a pump to adjust a flow rate through the reactor chamber, wherein the pump is further configured to adjust a fluidized bed expansion and porosity.

16. The apparatus of claim 1, wherein the recirculation tank is shielded from the atmosphere.

17. The apparatus of claim 16, further comprising a nitrogen gas inlet in the recirculation tank, wherein the nitrogen gas is sent into the recirculation take to help create a redox condition.

18. The apparatus of claim 16, wherein the recirculation tank is further configured to monitor any of the following: oxygen concentration, oxidation/reduction potential, and temperature.

19. The apparatus of claim 16, wherein the recirculation tank is configured for at least any one of a gas exhaust, a liquid sampling, and a chemical addition.

20. The apparatus of claim 16, wherein the apparatus further comprises at least one heat exchanger to set the temperature of the solution in the recirculation tank, wherein the heat exchanger is configured to set the temperature to below 100° C.

21. The apparatus of claim 1, further comprising a centrifugal separator connected between an output of the reactor chamber and an input of the recirculation tank.

22. A system to reduce a concentration of perchlorate ions in a water solution, the system comprising:
a reactor chamber having the water solution and suspended iron particles, wherein the water solution comprises perchlorate ions, wherein the reactor chamber is configured for the water solution to flow through the reactor chamber and to contact the suspended iron particles;
a recirculation tank connected with the reactor chamber and configured to receive water;
a separator apparatus to keep iron separated from water reaching the recirculation tank; and
an ultraviolet (UV) lamp to apply ultraviolet light to the water solution in the reactor chamber.

23. The system of claim 22, wherein the recirculation tank and the reactor chamber are configured to recycle water to reduce a concentration of perchlorate ions from the water.

24. The system of claim 22, further comprising a pump to recycle water between the recirculation tank and the reactor chamber.

25. The system of claim 22, wherein the reactor chamber is further configured to keep iron particles suspended in the reactor chamber when water is removed from reactor chamber.

26. The system of claim 22, wherein the separator apparatus comprises a filter to filter the iron particles from the water.

27. The system of claim 22, further comprising a centrifugal separator to filter the iron particles from the water.

28. The system of claim 22, wherein a substantial portion of the iron particles in the system are kept suspended in the reactor chamber.

29. The system of claim 22, wherein a first output of the centrifugal separator is connected with the recirculation tank, and wherein the first output of the centrifugal separator comprises an output for water.

30. The system of claim 22, wherein a second output of the centrifugal separator is configured for iron particles.

31. The system of claim 30, wherein the system comprises one or more connections between the centrifugal separator and the reactor chamber to recirculate iron particles filtered in the centrifugal separator.

32. The system of claim 31, wherein the one or more connections comprise an injector apparatus to retrieve the iron particles from the second output of the centrifugal separator and send the iron particles to the reactor chamber.

33. A system to reduce an amount of perchlorate ions in a water solution, the system comprising:
a fluidized bed photochemical reactor (FBPR) holding the water solution and the suspended iron particles, wherein the water solution comprises perchlorate ions, wherein the FBPR is configured to place the water solution in contact with the suspended iron particles, and wherein the suspended iron particles are left in the FBPR when the water is removed;
an ultraviolet (UV) source to apply UV light to the water solution in the FBPR, wherein UV light serves as a catalyst in a reaction for removing the perchlorate ions from the water solution;
a recirculation tank connected with the FBPR to hold water with a reduced concentration of perchlorate ions; and
a pump configured to recirculate water through the recirculation tank and the reactor chamber.

34. The system of claim 33, wherein the FBPR is configured to keep the iron particles in suspension in a fluidized bed.

35. The system of claim 33, wherein the FBPR comprises at least two concentric cylindrical tubes, wherein two of the concentric cylindrical tubes comprise an inner quartz tube with the UV light source and an outer tube enclosing the FBPR.

36. A system to reduce a concentration of perchlorate ions in water, the system comprising:
a thin film reactor for the water and iron particles, wherein the water comprises perchlorate ions, wherein the thin film reactor is configured for the water to flow over a surface and mix with iron particles;
a separator apparatus to separate iron particles from the water; and
an ultraviolet (UV) lamp to apply ultraviolet light to the water in the thin film reactor.

37. The system of claim 36, wherein the system is configured such that the UV lamp does not contact the water.

38. The system of claim 36, further comprising an oxidation/reduction potential (ORP) monitor.

39. The system of claim 36, wherein the thin-film reactor is at an angle with respect to ground to allow water and iron particles to flow over the surface.

40. The system of claim 39, wherein the angle is configured such that iron particles are in suspension.

41. The system in claim 36, wherein the system is configured such that iron particles are recirculated through the thin-film reactor.

42. The system in claim 36, wherein the thin-film reactor comprises an inlet for iron particles and water, and an outlet with iron particles and water.

43. The system of claim 42, wherein the thin-film reactor is configured to reduce an amount of perchlorate ions in the water flowing over the surface.

44. The system of claim 36, further comprising a pump to send water and iron particles into the thin film reactor.
